(19) United States
(12) Patent Application Publication
(10) Pub. No.: US 2025/0159528 A1
(43) Pub. Date: May 15, 2025

(54) METHODS FOR CONFIGURING A TERMINAL NODE WITH A MEASUREMENT CONFIGURATION OF A REFERENCE SIGNAL IN A NON-TERRESTRIAL (NTN) NETWORK, A NETWORK NODE, A TERMINAL NODE AND COMPUTER READABLE STORAGE MEANS

(71) Applicant: Telefonaktiebolaget LM Ericsson (publ), Stockholm (SE)

(72) Inventors: Ming Li, Stockholm (SE); Zhixun Tang, Beijing (CN)

(21) Appl. No.: 18/838,298

(22) PCT Filed: Feb. 14, 2023
(86) PCT No.: PCT/SE2023/050124

§ 371 Date: Aug. 14, 2024

(30) Foreign Application Priority Data
Feb. 14, 2022 (WO) PCT/CN2022/076168

(51) Int. Cl. H04W 24/10; H04B 7/185; H04L 5/00

(52) U.S. Cl. CPC H04W 24/10; H04B 7/18513; H04L 5/0048

(57) ABSTRACT

The present disclosure provides a method (100) in a network node for configuring a terminal node with a measurement configuration of a type of reference signal in a Non-Terrestrial Network, NTN. The measurement configuration includes at least one of an SMTC configuration and a MG configuration. The method (100) includes: determining (s110) the measurement configuration based on an occupied time length of SMTC or MG in one measurement periodicity being not higher than a threshold; and informing (s120) the terminal node of the determined measurement configuration to be used for performing a measurement procedure of the type of reference signal. Corresponding methods at the terminal node, the network node, terminal nodes, and computer readable medium are also provided.

### TECHNICAL FIELD

The present disclosure relates to wireless communication in a non-terrestrial network, and more particularly, to network nodes, terminal nodes and methods therein for configuring a measurement mechanism of a reference signal in a non-terrestrial network.

### BACKGROUND

There is an ongoing resurgence of satellite communications. Several plans for satellite networks have been announced in the past few years. Satellite networks could complement mobile networks on the ground by providing connectivity to underserved areas and multicast/broadcast services.

To benefit from the strong mobile ecosystem and economy of scale, adapting the terrestrial wireless access technologies including LTE and NR for satellite networks is drawing significant interest, which has been reflected in the 3GPP standardization work.

In 3GPP Release 15, the first release of the 5G system (5GS) was specified. This is a new generation's radio access technology intended to serve use cases such as enhanced mobile broadband (eMBB), ultra-reliable and low latency communication (URLLC), and mMTC. 5G includes the New Radio (NR) access stratum interface and the 5G Core Network (5GC). The NR physical and higher layers are reusing parts of the LTE specification, and to that add needed components when motivated by new use cases. One such component is the introduction of a sophisticated framework for beam forming and beam management to extend the support of the 3GPP technologies to a frequency range going beyond 6 GHZ.

In Release 15, 3GPP started the work to prepare NR for operation in a Non-Terrestrial Network (NTN). The work was performed within the study item “NR to support Non-Terrestrial Networks” and resulted in 3GPP TR 38.811. In Release 16 of 3GPP 38.821, the work to prepare NR for operation in an NTN network continued with the study item “Solutions for NR to support Non-Terrestrial Network”. In parallel the interest to adapt NB-IoT and LTE-M for operation in NTN is growing. As a consequence, 3GPP Release 17 contains both a work item on NR NTN and a study item on NB-IoT and LTE-M support for NTN.

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite
Access link, or service link, that refers to the link between a satellite and a UE.

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

Two basic architectures can be distinguished for satellite communication networks, depending on the functionality of the satellites in the system:
Transparent payload (also referred to as bent pipe architecture). The satellite forwards the received signal between the terminal and the network equipment on the ground with only amplification and a shift from uplink frequency to downlink frequency. When applied to general 3GPP architecture and terminology, the transparent payload architecture means that the gNB is located on the ground and the satellite forwards signals/data between the gNB and the UE.
Regenerative payload. The satellite includes on-board processing to demodulate and decode the received signal and regenerate the signal before sending it back to the earth. When applied to general 3GPP architecture and terminology, the regenerative payload architecture means that the gNB is located in the satellite.

In the work item for NR NTN in 3GPP release 17, only the transparent payload architecture is considered.

A satellite network or satellite based mobile network may also be called as non-terrestrial network (NTN). On the other hand mobile network with base stations on the group may also be called as terrestrial network (TN) or non-NTN network. A satellite within NTN may be called as NTN node, NTN satellite or simply a satellite.

FIG. 1 shows an exemplary architecture of a satellite network with bent pipe transponders (i.e. the transparent payload architecture). The satellite communicates with the gateway via a feeder link, and communicates with the device via an access link by forming a spotbeam covering the device. The gNB may be integrated in the gateway or connected to the gateway via a terrestrial connection (e.g., wire, optical fiber, wireless link). The satellite forwards signals/data between the gNB and the device.

A communication satellite typically generates several beams over a given area. The footprint of a beam is usually in an elliptic shape, which has traditionally been considered as a cell, but cells consisting of the coverage footprint of multiple beams are not excluded in the 3GPP work. The footprint of a beam is also often referred to as a spotbeam. The footprint of a beam may move over the earth's surface with the satellite movement or may be earth fixed with a beam pointing mechanism used by the satellite to compensate for the satellite's motion (where the latter may be referred to as quasi-earth-fixed beams or quasi-earth-fixed cells). The size of a spotbeam depends on the system design, which may range from tens of kilometers to a few thousands of kilometers.

In a LEO or MEO communication system, a large number of satellites deployed over a range of orbits are required to provide continuous coverage across the full globe. Launching a mega satellite constellation is both an expensive and time-consuming procedure. It is therefore expected that all LEO and MEO satellite constellations for some time will only provide partial earth-coverage. In case of some constellations dedicated to massive IoT services with relaxed latency requirements, it may not even be necessary to support full earth-coverage. It may be sufficient to provide occasional or periodic coverage according to the orbital period of the constellation.

A 3GPP device in RRC_IDLE or RRC_INACTIVE state is required to perform number of procedures including measurements for mobility purposes, paging monitoring, logging measurement results, tracking area update, and search for a new PLMN to mention a few. These procedures will consume power in devices, and a general trend in 3GPP has been to allow for relaxation of these procedures to prolong device battery life. This trend has been especially pronounced for IoT devices supported by reduced capability (redcap), NB IoT and LTE M.

Propagation delay is an important aspect of satellite communications that is different from the delay expected in a terrestrial mobile system. For a bent pipe satellite network, the round-trip delay may, depending on the orbit height, range from tens of ms in the case of LEO satellites to several hundreds of ms for GEO satellites. As a comparison, the round-trip delays in terrestrial cellular networks are typically below 1 ms.

The distance between the UE and a satellite can vary significantly, depending on the position of the satellite and thus the elevation angle & seen by the UE. Assuming circular orbits, the minimum distance is realized when the satellite is directly above the UE (ϵ=90°), and the maximum distance when the satellite is at the smallest possible elevation angle. Table 1 shows the distances between satellite and UE for different orbital heights and elevation angles together with the one-way propagation delay and the maximum propagation delay difference (the difference from the propagation delay at ϵ=90°). Note that Table 1 assumes regenerative payload architecture. For the transparent payload case, the propagation delay between gateway and satellite needs to be considered as well, unless the base station corrects for that.

TABLE 1
Propagation delay for different orbital heights and elevation angles

| | | | | One-way | | Propagation |
|---|---|---|---|---|---|---|
| Orbital | Elevation | Distance | | propagation | | delay |
| height | angle | UE <−> satellite | | delay | | difference |
| 600 km | 90° | 600 | km | 2.0 | ms | — |
| | 30° | 1075 | km | 3.6 | ms | 1.6 ms |
| | 10° | 1932 | km | 6.4 | ms | 4.4 ms |
| 1200 km | 90° | 1200 | km | 4.0 | ms | — |
| | 30° | 1999 | km | 6.7 | ms | 2.7 ms |
| | 10° | 3131 | km | 10.4 | ms | 6.4 ms |
| 35786 km | 90° | 35786 | km | 119.4 | ms | — |
| | 30° | 38609 | km | 128.8 | ms | 9.4 ms |
| | 10° | 40581 | km | 135.4 | ms | 16.0 ms |

The propagation delay may also be highly variable due to the high velocity of the LEO and MEO satellites and change in the order of 10-100 us every second, depending on the orbit altitude and satellite velocity.

The following can be considered as main challenges that need to be addressed in NTN: moving satellites (resulting in moving cells or switching cells), and long propagation delays.
Moving satellites (resulting in moving or switching cells): The default assumption in terrestrial network design, e.g. NR or LTE, is that cells are stationary. This is not the case in NTN, especially when LEO satellites are considered. A LEO satellite may be visible to a UE on the ground only for a few seconds or minutes. There are two different options for LEO deployment. The beam/cell coverage is fixed with respect to a geographical location with earth-fixed beams, i.e. steerable beams from satellites ensure that a certain beam covers the same geographical area even as the satellite moves in relation to the surface of the earth. On the other hand, with moving beams a LEO satellite has fixed antenna pointing direction in relation to the earth's surface, e.g. perpendicular to the earth's surface, and thus cell/beam coverage sweeps the earth as the satellite moves. In that case, the spotbeam, which is serving the UE, may switch every few seconds.
Long propagation delays: The propagation delays in terrestrial mobile systems are usually less than 1 millisecond. In contrast, the propagation delays in NTN can be much longer, ranging from several milliseconds (LEO) to hundreds of milliseconds (GEO) depending on the altitudes of the spaceborne or airborne platforms deployed in the NTN.

In terrestrial networks (TNs) the relative location in time of an SSB between a serving cell and a neighbor cell is fixed. The propagation delay within each cell depends on the cell size and UE location, and from UE's perspective it will only vary due to UE movement.

On the contrary, in low-earth orbit (LEO) scenarios, even the propagation delay between UE and serving cell will vary over time, due to the movement of the satellite. Furthermore, the propagation delays towards neighbor cells on neighboring satellites will also change over time. The scenario will become worse when also accounting for feeder link delay and will increase with increasing satellite altitude.

Serving cell and target cell might not be necessarily time-synchronized and frame-synchronized when belonging to different satellites. The resulting time offset in SSB transmission between different cells needs to be considered.

### SUMMARY

It is an object of the present disclosure to provide network nodes, terminal nodes and methods therein, enabling the network node and/or the terminal node to conditionally or adaptively adjust measurement configuration of the reference signal.

According to a first aspect of the present disclosure, a method in a network node for configuring a terminal node with a measurement configuration of a type of reference signal in a NTN is provided. The measurement configuration comprises at least one of a Synchronization Signal Block, SSB, Measurement Time Configuration, SMTC configuration, and a Measurement Gap, MG, configuration. The method may include: determining the measurement configuration based on an occupied time length of SMTC or MG in one measurement periodicity being not higher than a threshold; and informing the terminal node of the determined measurement configuration to be used for performing a measurement procedure of the type of reference signal.

In an exemplary embodiment, determining the measurement configuration may further comprise determining the measurement configuration by taking satellite types in the NTN into account.

As a specific example of the criteria, the network node may determine the SMTC configuration based on satellite type and satellite ephemeris data. In general, the network node may determine the SMTC configuration based on a relation or a function of satellite information (Sk, m, l), where k is a number or an index/identifier of satellite, m is a number or index of frequency layer, l is a number or index of cells. For example, a SMTC configuration for LEO satellites shall contain fewer satellites compared to GEO satellites. As another example, the SMTC configuration may be selected, the satellites for which satisfy the satellite type and satellite ephemeris data predefined or configured by the network node.

In an exemplary embodiment, determining the measurement configuration by taking satellite types into account may comprise selecting different scaling factors of the measurement procedure corresponding to the measurement configuration for different types of satellites.

In an exemplary embodiment, determining the measurement configuration may further comprise determining the measurement configuration based on a number of satellites for which reference signals of the type are measured within one SMTC periodicity, wherein for Low Earth Orbit, LEO, satellites the number of satellites for which reference signals of the type are measured within one SMTC periodicity is less than that for Geostationary Earth Orbit, GEO, satellites.

In an exemplary embodiment, determining the measurement configuration may further comprise applying a scaling factor to measurement period of the measurement procedure corresponding to the measurement configuration if two SMTC partially overlap and the satellites for which reference signals of the type are in the overlapped SMTCs have Doppler shift.

In an exemplary embodiment, different scaling factors are applied for different degree of overlapping between two SMTCs.

In an exemplary embodiment, determining the measurement configuration may further comprise determining the measurement configuration based on a number of SMTCs the terminal node is capable of supporting.

In an exemplary embodiment, determining the measurement configuration may further comprise applying a scaling factor to measurement period of the measurement procedure corresponding to the measurement configuration based on a number of SMTCs in one measurement periodicity.

In an exemplary embodiment, the measurement configuration comprises a SMTC configuration comprising at least one of:
SMTC periodicity;
SMTC length in time or duration;
SMTC offset; and
number of SMTC in one measurement periodicity.

In an exemplary embodiment, the measurement configuration comprises a measurement gap configuration comprising at least one of:
MG periodicity;
MG length in time or duration; and
MG offset.

In an exemplary embodiment, determining the measurement configuration may comprise selecting one or more measurement configuration from a group of measurement configurations, and informing the terminal node of the determined measurement configuration may comprise informing the terminal node of the one or more selected measurement configurations.

In an exemplary embodiment, the method may further comprise receiving capability information reported from the terminal node, indicating a capability of the terminal node with respect to a number of SMTCs that can be dealt with in the measurement procedure, and determining the measurement configuration may comprise determining the measurement configuration by taking the reported capability information into account.

In an exemplary embodiment, the method may further comprise receiving configuration information on the measurement configuration reported from the terminal node, and determining the measurement configuration may comprise updating the measurement configuration by taking the reported configuration information into account.

In an exemplary embodiment, the configuration information is an indication of a measurement configuration of the type of reference signal or an indication of a configuration parameter included in a measurement configuration of the type of reference signal.

In an exemplary embodiment, determining the measurement configuration may further comprise updating the measurement configuration in response to receiving information related to the measurement configuration from the terminal node.

According to a second aspect of the present disclosure, a network node is provided. The network node may include a transceiver, a processor and a memory. The memory contains instructions executable by the processor whereby the network node is operative to perform the method according to the above first aspect.

According to a third aspect of the present disclosure, a computer readable storage medium is provided. The computer readable storage medium has computer program instructions stored thereon. The computer program instructions, when executed by a processor in a network node, cause the network node to perform the method according to the above first aspect.

According to a fourth aspect of the present disclosure, a method in a terminal node for performing a measurement procedure of a type of reference signal in a NTN is provided. The measurement configuration comprises at least one of a Synchronization Signal Block, SSB, Measurement Time Configuration, SMTC configuration, and a Measurement Gap, MG, configuration. The method may include: receiving information on a measurement configuration of the type of reference signal from a network node, the measurement configuration being determined so that an occupied time length of SMTC or MG in one measurement periodicity is not higher than a threshold; and performing a measurement procedure of the type of reference signal based on the measurement configuration.

According to a fifth aspect of the present disclosure, a terminal node is provided. The terminal node may include a transceiver, a processor and a memory. The memory contains instructions executable by the processor whereby the terminal node is operative to perform the method according to the above fourth aspect.

According to a sixth aspect of the present disclosure, a computer readable storage medium is provided. The computer readable storage medium has computer program instructions stored thereon. The computer program instructions, when executed by a processor in a terminal node, cause the terminal node to perform the method according to the above fourth aspect.

With the embodiments of the present disclosure, a measurement mechanism of a reference signal in a non-terrestrial network is provided, in which the network node and the terminal node conditionally or adaptively adjust measurement configuration of the reference signal.

### BRIEF DESCRIPTION OF THE DRAWINGS

The above and other objects, features and advantages will be more apparent from the following description of embodiments with reference to the figures, in which:

FIG. 1 shows an exemplary architecture of a satellite network with bent pipe transponders;

FIG. 2 shows an illustration of SSB, SMTC window, and measurement gap;

FIG. 3 illustrates a scenario where there are multiple (4) SMTCs per MO or per frequency layer totally in one occasion which is broadcasted by the network, and there are SMTC offset among the 4 SMTCs;

FIG. 4 illustrates two exemplary cases where different SMTC windows are used;

FIG. 5 is a flowchart illustrating a method in a network node according to an exemplary embodiment of the present disclosure;

FIG. 6 is a flowchart illustrating a method in a terminal node according to an exemplary embodiment of the present disclosure;

FIG. 7 is a block diagram of a network node according to another embodiment of the present disclosure;

FIG. 8 is a block diagram of a network node according to another embodiment of the present disclosure;

FIG. 9 is a block diagram of a terminal node according to an exemplary embodiment of the present disclosure;

FIG. 10 is a block diagram of a terminal node according to another embodiment of the present disclosure;

FIG. 11 schematically illustrates a telecommunication network connected via an intermediate network to a host computer;

FIG. 12 is a generalized block diagram of a host computer communicating via a base station with a user equipment over a partially wireless connection;

FIGS. 13 to 16 are flowcharts illustrating methods implemented in a communication system including a host computer, a base station and a user equipment.

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in references as follows:
1) 3GPP 38.311, V15.4.0 (2020-09),
2) 3GPP 38.821, V16.0.0 (2019-12),
3) 3GPP 38.133, V17.4.0 (2021-12), and
4) 3GPP 38.331, V16.7.0 (2021-12).

As used herein, the term “satellite” is often used even when a more appropriate term would be “gNB associated with the satellite”. The term “satellite” may also be called as a satellite node, a NTN node, node in the space etc. Here, gNB associated with a satellite might include both a regenerative satellite, where the gNB is the satellite payload, i.e., the gNB is integrated with the satellite or a transparent satellite, where the satellite payload is a relay and gNB is on the ground (i.e., the satellite relays the communication between the gNB on the ground and the UE).

Time period or duration over which a UE can maintain connection, or can camp on, or can maintain communication, and so on to a satellite or a gNB by UE is referred to as term “coverage time” or “serving time” or “network availability” or “sojourn time” or “dwell time”, etc. The term ‘Non-coverage time’, also known as “non-serving time” or “network unavailability”, or “non-sojourn time” or “non-dwell time” refers to a period of time during which a satellite or gNB cannot serve or communicate or provide coverage to a UE. Another way to interpret the availability is that is not about a satellite/network strictly not able to serve the UE due to lack of coverage but that UE does not need to measure certain “not likely to be serving cell (satellite via which serving cell is broadcasted)”. In this case, the terminology may still be as in no coverage case or it may be different, e.g. “no need to measure”.

The term node is used which can be a network node or a user equipment (UE). Examples of network nodes are NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, nodes in distributed antenna system (DAS), core network node (e.g. MSC, MME etc), O&M, OSS, SON, positioning node (e.g. E-SMLC), etc.

The term “network node” or “network device” refers to a device in a wireless communication network via which a terminal node accesses the network and receives services therefrom. The network node or network device refers to a base station (BS), an access point (AP), or any other suitable device in the wireless communication network. The BS may be, for example, a node B (NodeB or NB), an evolved NodeB (eNodeB or eNB), or gNB, a Remote Radio Unit (RRU), a radio header (RH), a remote radio head (RRH), a relay, a low power node such as a femto, a pico, and so forth. Yet further examples of the network node may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network node may represent any suitable device (or group of devices) capable, configured, arranged, and/or operable to enable and/or provide a terminal node access to the wireless communication network or to provide some service to a terminal node that has accessed the wireless communication network.

The term “terminal node” refers to any end device that can access a wireless communication network and receive services therefrom. By way of example and not limitation, the terminal node refers to a mobile terminal, user equipment (UE), or other suitable devices. The UE may be, for example, a Subscriber Station (SS), a Portable Subscriber Station, a Mobile Station (MS), or an Access Terminal (AT). The terminal node may include, but not limited to, portable computers, desktop computers, image capture terminal devices such as digital cameras, gaming terminal devices, music storage and playback appliances, a mobile phone, a cellular phone, a smart phone, voice over IP (VOIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal node”, “terminal device”, “terminal”, “user equipment” and “UE” may be used interchangeably. As one example, a terminal node may represent a UE configured for communication in accordance with one or more communication standards promulgated by the 3rd Generation Partnership Project (3GPP), such as 5G standards, and/or the future standards. As used herein, a “user equipment” or “UE” may not necessarily have a “user” in the sense of a human user who owns and/or operates the relevant device. In some embodiments, a terminal node may be configured to transmit and/or receive information without direct human interaction. For instance, a terminal node may be designed to transmit information to a network node on a predetermined schedule, when triggered by an internal or external event, or in response to requests from the wireless communication network. Instead, a UE may represent a device that is intended for sale to, or operation by, a human user but that may not initially be associated with a specific human user.

As yet another example, in an Internet of Things (IoT) scenario, a terminal node may represent a machine or other device that performs monitoring and/or measurements, and transmits the results of such monitoring and/or measurements to another terminal node and/or network equipment. The terminal node may in this case be a machine-to-machine (M2M) device, which may in a 3GPP context be referred to as a machine-type communication (MTC) device. As one particular example, the terminal node may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal node may represent a vehicle or other equipment that is capable of monitoring and/or reporting on its operational status or other functions associated with its operation.

As used herein, a downlink transmission refers to a transmission from a network node to a terminal node, and an uplink transmission refers to a transmission in an opposite direction.

The term radio access technology, or RAT, may refer to any RAT e.g. UTRA, E-UTRA, narrow band internet of things (NB-IoT), WiFi, Bluetooth, next generation RAT, New Radio (NR), 4G, 5G, NR NTN, IoT NTN, LTE NTN, etc. Any of the equipment denoted by the term node, network node or radio network node may be capable of supporting a single or multiple RATs.

The term signal or radio signal used herein can be any physical signal or physical channel. Examples of DL physical signals are reference signal (RS) such as PSS, SSS, CSI-RS, DMRS signals in SS/PBCH block (SSB), discovery reference signal (DRS), CRS, PRS etc. RS may be periodic e.g. RS occasion carrying one or more RSs may occur with certain periodicity e.g. 20 ms, 40 ms etc. The RS may also be aperiodic. Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with respect to reference time (e.g. serving cell's SFN) etc. Therefore, SMTC occasion may also occur with certain periodicity e.g. 5 ms, 10 ms, 20 ms, 40 ms, 80 ms and 160 ms. Examples of UL physical signals are reference signal such as SRS, DMRS etc. The term physical channel refers to any channel carrying higher layer information e.g. data, control etc. Examples of physical channels are PBCH, NPBCH, PDCCH, PDSCH, sPUCCH, sPDSCH, sPUCCH, sPUSCH, MPDCCH, NPDCCH, NPDSCH, E-PDCCH, PUSCH, PUCCH, NPUSCH etc.

References in the specification to “one embodiment,” “an exemplary embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an exemplary embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

NR synchronization signal (SS) consists of primary SS (PSS) and secondary SS (SSS). NR physical broadcast channel (PBCH) carries the very basic system information. The combination of SS and PBCH is referred to as SSB in NR. Multiple SSBs are transmitted in a localized burst set. Within an SS burst set, multiple SSBs can be transmitted in different beams. The transmission of SSBs within a localized burst set is confined to a 5 ms window. The set of possible SSB time locations within an SS burst set depends on the numerology which in most cases is uniquely identified by the frequency band. The SSB periodicity can be configured from the value set {5, 10, 20, 40, 80, 160} ms (where the unit used in the configuration is subframe, which has a duration of 1 ms).

A UE does not need to perform measurements with the same periodicity as the SSB periodicity. Accordingly, the SSB measurement time configuration (SMTC) has been introduced for NR. The signaling of SMTC window informs the UE of the timing and periodicity of SSBs that the UE can use for measurements. The SMTC window periodicity can be configured from the value set {5, 10, 20, 40, 80, 160} ms, matching the possible SSB periodicities. The SMTC window duration can be configured from the value set {1, 2, 3, 4, 5} ms (where the unit used in the configuration is subframe, which has a duration of 1 ms).

The UE may use the same RF module for measurements of neighboring cells and data transmission in the serving cell. Measurement gaps allow the UE to suspend the data transmission in the serving cell and perform the measurements of neighboring cells. The measurement gap repetition periodicity can be configured from the value set {20, 40, 80, 160} ms, the gap length can be configured from the value set {1.5, 3, 3.5, 4, 5.5, 6, 10, 20} ms. Usually, the measurement gap length is configured to be larger than the SMTC window duration to allow for RF retuning time. Measurement gap time advance is also introduced to fine tune the relative position of the measurement gap with respect to the SMTC window. The measurement gap timing advance can be configured from the value set {0, 0.25, 0.5} ms.

FIG. 2 provides an illustration of SSB, SMTC window, and measurement gap.

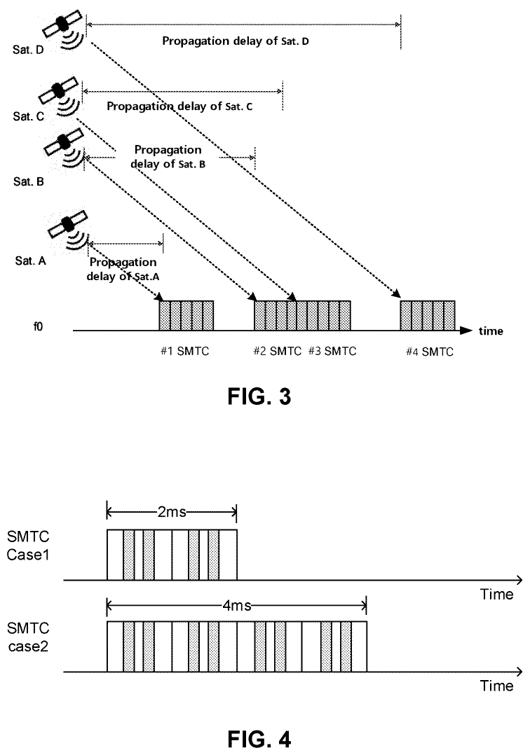

Multiple SMTC/MG configurations are enabled by introducing different new offsets. As shown in FIG. 3, there are 4 SMTCs per MO (measurement object) or per frequency layer totally in one occasion which is broadcasted by the network, in which SMTC1 and SMTC4 aren't overlapped, SMTC2 and SMTC3 are overlapped partly due to different offsets. In the figure, SMTC1, SMTC2, SMTC3 and SMTC4 indicate indexes of multi-SMTC configured by the network, and they can also be referred to exact RRC IE parameters.

The UE receives the configuration and applies the pre-configured updates according to the received configuration. Such a SMTC window configuration could be referred to as a dynamic SMTC window configuration or a dynamic SMTC.

In NTN, RAN2 has agreed to configure the UE with SMTC configurations that are per list of cells: This as such exists in TS 38.331 enabling up to 4 different SMTC periodicities, and duration is kept as {sf1, sf2, sf3, sf4, sf5}.

| SSB-MTC3List-r16 ::= | | SEQUENCE (SIZE(1..4)) |
|---|---|---|
| | | OF SSB-MTC3-r16 |
| SSB-MTC3-r16 ::= | | SEQUENCE { |
| periodicityAndOffset-r16 | | CHOICE { |
| sf5-r16 | | INTEGER (0..4), |
| sf10-r16 | | INTEGER (0..9), |
| sf20-r16 | | INTEGER (0..19), |
| sf40-r16 | | INTEGER (0..39), |
| sf80-r16 | | INTEGER (0..79), |
| sf160-r16 | | INTEGER (0..159), |
| sf320-r16 | | INTEGER (0..319), |
| sf640-r16 | | INTEGER (0..639), |
| sf1280-r16 | | INTEGER (0..1279) |
| }, | | |
| duration-r16 | | ENUMERATED {sf1, sf2, sf3, |
| | | sf4, sf5}, |
| pci-List-r16 | | SEQUENCE (SIZE |
| | | (1..maxNrofPCIsPerSMTC)) OF |
| | | PhysCellId |
| OPTIONAL, | -- Need M | |
| ssb-ToMeasure-r16 | | SetupRelease { SSB-ToMeasure } |
| OPTIONAL | -- Need M | |

}

FIG. 4 illustrates two exemplary cases where different SMTC windows are used. As shown, case 1 uses an SMTC window of 2 ms, while case 2 uses a 4 ms SMTC window.

In low activity RRC states (e.g. in RRC_IDLE/RRC_INACTIVE state) UE needs to measure the SSB of neighboring cells to perform cell reselection. In low activity RRC state the UE typically performs measurement or measurement procedure on signals (e.g. SSB) of one or more cells (e.g. satellites) once every Kth DRX cycle e.g. K=1, K=2 etc. To ensure UE can detect the SSB of neighboring cell accurately, system information of current serving cell will broadcast the SMTC configuration of neighboring cells per carrier frequency, the configurations of SMTCs e.g. SMTC1, SMTC2 etc. In one example, the number of SMTC configurations implemented by UE is M1 which may be less than or equal to the maximum number (M) of SMTC configured by the network.

In RRC_CONNECTED state, the configurations of SMTCs and MGs including SMTC indexes or identifiers are signaled to particular UE by the network, e.g. through measurement configuration in RRC signaling dedicated for the UE. In one example, the number of SMTC or MG configurations implemented by UE is M2 or N2 which may be less than or equal to the maximum number (M) of SMTC or the maximum number (N) of MG configured by the network.

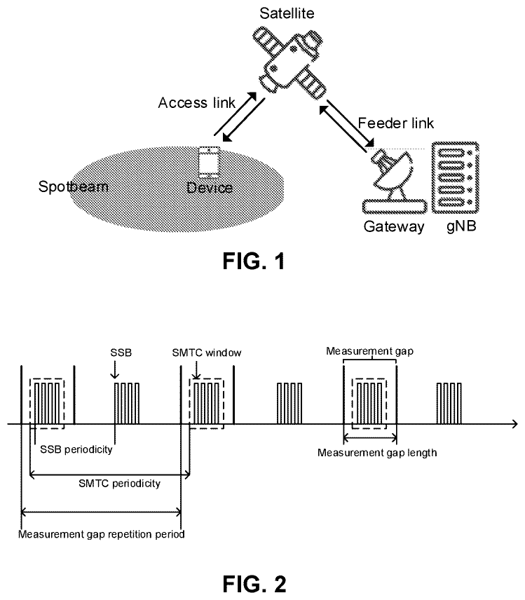

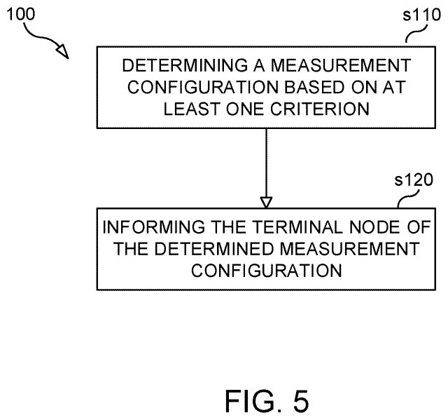

FIG. 5 is a flowchart illustrating a method 100 according to an exemplary embodiment of the present disclosure. The method 100 can be performed at a network node, e.g., a gNB, and is to configure a terminal node with a measurement configuration of a type of reference signal. The measurement configuration comprises at least one of a SMTC configuration and a MG configuration. The method 100 is applicable in a NTN network, as shown in FIG. 1.

At step s110, the network node determines a measurement configuration based on at least one criterion. The criterion may be that an occupied time length of SMTC or MG in one measurement periodicity is not higher than a threshold.

As a specific example of the criterion, the network node may determine the measurement configuration to avoid percentage of scheduling restriction or data throughput loss due to occupation of SMTC or MG in one measurement periodicity higher than a threshold.

At step s120, the network node informs the terminal node of the determined measurement configuration. The measurement configuration is to be used at the terminal node for performing a measurement procedure of the type of reference signal.

In an exemplary embodiment, step s110 of determining the measurement configuration may further comprise determining the measurement configuration by taking satellite types in the NTN into account.

In an exemplary embodiment, the step of determining the measurement configuration by taking satellite types into account may comprise selecting different scaling factors of the measurement procedure corresponding to the measurement configuration for different types of satellites.

As a specific example of the criterion, the measurement procedure may be defined with group or set, e.g. MP1, MP2 and so on. Different group or set of measurement procedure comprise different measurement delay or measurement time. The network node may indicate the terminal node to follow group or set of measurement procedure with signaling, including RRC signaling, DCI and MAC command. An example of group or set of measurement procedure with different measurement delay or measurement time (here, TNₘₑₐₛᵤᵣₑₘₑₙₜ represents a default measurement delay or measurement time) is depicted in the table below, where the function f(a, TNₘₑₐₛᵤᵣₑₘₑₙₜ) represents a*TNₘₑₐₛᵤᵣₑₘₑₙₜ.

| Signaling for measurement procedure | measurement delay |
|---|---|
| MP1 | TNₘₑₛₐᵤᵣₑₘₑₙₜ |
| MP2 | f(K2, TNₘₑₛₐᵤᵣₑₘₑₙₜ) |
| MP3 | f(K3, TNₘₑₛₐᵤᵣₑₘₑₙₜ) |

### Signaling for Measurement Procedure

In a specific example, K=2 in MP2 when measurement for GEO satellite and LEO Earth-fixed satellite; K=1/2 in MP3 when measurement for LEO Earth-moving satellite.

In another specific example, K=2 in MP2 when measurement for satellites with huge Doppler shift each other; K=1/2 in MP3 when measurement for satellites with little Doppler shift each other.

In an exemplary embodiment, step s110 of determining the measurement configuration may further comprise determining the measurement configuration based on a number of satellites for which reference signals of the type are measured within one SMTC periodicity, wherein for LEO satellites the number of satellites for which reference signals of the type are measured within one SMTC periodicity is less than that for GEO satellites.

As a specific example of the criterion, the network node may determine the measurement configuration based on satellite type and satellite ephemeris data. In general, the network node may determine the measurement configuration based on a relation or a function of satellite information (Sk, m, l), where k is a number or an index/identifier of satellite, m is a number or index of frequency layer, l is a number or index of cells. For example, due to moving characteristics, a SMTC configuration for LEO satellites shall contain fewer satellites compared to GEO satellites. As another example, the SMTC configuration may be selected, the satellites for which satisfy the satellite type and satellite ephemeris data predefined or configured by the network node.

In an exemplary embodiment, step s110 of determining the measurement configuration may further comprise applying a scaling factor to measurement period of the measurement procedure corresponding to the measurement configuration if two SMTC partially overlap and the satellites for which reference signals of the type are in the overlapped SMTCs have Doppler shift.

In an exemplary embodiment, different scaling factors are applied for different degree of overlapping between two SMTCs.

A specific example is that measurement period can be extended or scaled autonomously once overlapping (partial collision or close in time (e.g. within certain time margin) but do not overlap in time) MG occurs.

Another specific example is that measurement period can be extended or scaled autonomously once overlapping (partial collision or close in time (e.g. within certain time margin) but do not overlap in time) SMTC occurs and the satellites which SSBs are in the two SMTCs have significant Doppler shift.

In an exemplary embodiment, step s110 of determining the measurement configuration may further comprise determining the measurement configuration based on a number of SMTCs the terminal node is capable of supporting.

Measurement configurations supported by the terminal node, e.g. SMTC number that can be supported under different conditions may be indicated to the network by the terminal node. The terminal node may indicate that it can support certain number of SMTC configurations for any set of SMTC configuration parameters.

In an exemplary embodiment, step s110 of determining the measurement configuration may further comprise applying a scaling factor to measurement period of the measurement procedure corresponding to the measurement configuration based on a number of SMTCs in one measurement periodicity.

In a specific example, the measurement configuration is selected based on relation or function of satellite information (Sk, m, l), where k is number or index/identifier of satellite, m is number or index of frequency layer, l is number of or index of cells (e.g. more than one satellites connects one cell). In a specific example, the measurement delay is CSSF*N*Tsample*COUNT (Sk, m, l) where CSSF is a carrier specific scaling factor, N is a number of measurement samples per frequency layer, and Tsample is the measurement time per sample.

In an exemplary embodiment, the measurement configuration may comprise a SMTC configuration comprising at least one of:
SMTC periodicity;
SMTC length in time or duration;
SMTC offset; and
number of SMTC in one measurement periodicity.

In an exemplary embodiment, the measurement configuration may comprise a MG configuration comprising at least one of:
MG periodicity;
MG length in time or duration; and
MG offset.

In an exemplary embodiment, the network node may inform the terminal node of a measurement configuration, e.g., measurement configuration 1, measurement configuration 2. In the embodiment, step s110 may comprises a step of selecting one or more measurement configuration from a group of measurement configurations, and step s120 may comprise a step of informing the terminal node of the one or more selected measurement configurations. The informing may be performed by indicating the exact measurement configuration, i.e., all the measurement parameters in the measurement configuration, or by indicating the index of the measurement configuration. In the latter case, the terminal node is pre-provided with the mapping of the index of the measurement configuration and measurement parameters of the measurement configuration.

In an exemplary embodiment, the at least one criterion may be pre-defined and/or configured by the network node. In an exemplary embodiment, the at least one the at least one criterion may use at least one of:
received signal level, location, and time at the terminal node
information on frequency layer and cells
number of satellites
satellite types or satellite ephemeris data
cell information, such as cell number or cell number per satellite
scheduling restriction or data throughput loss due to occupation of SMTC or MG in one measurement periodicity
time in time assisted mobility
distance in distance assisted mobility.
Discontinuous Reception, DRX, of the terminal node

As a specific example of the criteria, the network node may determine the SMTC configuration based on a relation between a received signal level(S) at the terminal node in a cell and a signal level threshold (SH). For example, the SMTC configuration is selected as a SMTC configuration for which S is greater than the threshold (SH).

As an example of the criteria, the network node may determine the SMTC configuration based on a relation between a time duration (T) at the terminal node in a cell and a timing threshold (TH). For example, the SMTC configuration is selected as a SMTC configuration for which T is greater than the threshold (TH).

As an example of the criterion, the network node may determine the SMTC configuration based on cell number or cell number per satellite. In general, the network node may determine the SMTC configuration based on a relation or a function of cell information (Ck, m, l), where k is a number or index/identifier of cell, m is a number or index of frequency layer, l is a number or index of satellites per cell. For example, a SMTC configuration for LEO satellites shall contain fewer cells compared to GEO satellites. As another example, the SMTC configuration may be selected, the cells for which satisfy the cell information predefined or configured by the network node.

In an exemplary embodiment, the network node may determine the SMTC configuration by taking all or some of the above criteria into account.

In an exemplary embodiment, a MG configuration shall be determined with similar criteria to the SMTC configuration. In other words, above criteria for SMTC configuration also can be used in determining a MG configuration.

In an exemplary embodiment, the network node may adjust the measurement parameter used for the terminal node. For example, the measurement delay of the measurement procedure may be described as CSSF*N*Tsample, where CSSF is a carrier specific scaling factor, N is a number of measurement samples per frequency layer, and Tsample is the measurement time per sample. The network node may change the value of N for a particular scenario. In the embodiment, the method 100 may further comprise a step of determining at least one measurement parameter to be used in the measurement procedure, and a step of informing the terminal node of the determined measurement parameter.

In an exemplary embodiment, the terminal node may indicate the network node that it can support a number of SMTCs under different conditions, or it can support certain number of SMTC configurations for any set of SMTC configuration parameters. In the embodiment, the method 100 may further comprise a step of receiving capability information reported from the terminal node, indicating a capability of the terminal node with respect to a number of SMTCs that can be dealt with in the measurement procedure. In the embodiment, step s110 may take the reported capability information into account.

In an exemplary embodiment, the terminal node may indicate necessary or supplementary information for determining the measurement configuration to the network node. In the embodiment, the method 100 may further comprise a step of receiving configuration information on the measurement configuration reported from the terminal node. In the embodiment, step s110 may take the reported configuration information into account. In the embodiment, the configuration information may be an indication of a measurement configuration of the type of reference signal or an indication of a configuration parameter included in a measurement configuration of the type of reference signal. Examples of the information may include the SMTC configurations determined by the terminal node, including for example:
Exact SMTC configurations: offset of SMTCs, index or identifier of SMTCs, index or identifier of satellites, index or identifier of cells and so on.
Difference/offset between SMTCs determined by UE and SMTCs configured by network.

In an exemplary embodiment, the terminal node may indicate its allowed, preferred or suggested measurement procedure to the network node. In the embodiment, the method 100 may further comprise a step of receiving measurement information on the measurement procedure reported from the terminal node. In the embodiment, step s110 may take the reported measurement information into account. In the embodiment, the measurement information may be an indication of a measurement procedure of the reference signal or an indication of a measurement parameter to be used in a measurement procedure of the reference signal.

In an exemplary embodiment, the network node may update the measurement configuration based on a report from the terminal node. In the embodiment, step s110 may further comprise a step of updating the measurement configuration in response to receiving information related to the measurement configuration from the terminal node.

In an exemplary embodiment, the terminal node may indicate the network node that it has the capability to adapt the measurement configuration, e.g., SMTC window. In the embodiment, the method 100 may further comprise a step of transmitting an adapting enablement message to the terminal node which is capable of adapting the measurement configuration, to enable or disable the terminal node to adapt the measurement configuration. In an example, if the network node indicates to disable the adaptive SMTC windows, the terminal node shall perform measurements with respect to SMTC windows configured by the network node. In another example, if the network node indicates to enable the adaptive SMTC windows, the terminal node can select or shift SMTC windows based on calculation by itself.

In an exemplary embodiment, the terminal node may be triggered by the network node to perform the measurement procedure. For example, the network node configures the terminal node with the measurement configuration, where the terminal node holds on the performing of the measurement procedure corresponding to the measurement procedure until being commanded by the network node. In the embodiment, the method 100 may further comprise a step of transmitting a measurement enablement message to the terminal node to indicate the terminal node to perform the measurement procedure of the reference signal.

In an exemplary embodiment, the network node may perform informing or transmitting to the terminal node by RRC signaling, DCI or MAC command.

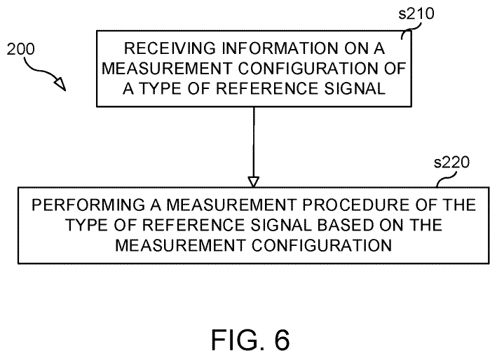

FIG. 6 is a flowchart illustrating a method 200 according to an exemplary embodiment of the present disclosure. The method 200 can be performed in a terminal node, e.g., a UE, and is to perform a measurement procedure of a type of reference signal. The measurement configuration comprises at least one of a SMTC configuration and a MG configuration. The method 200 is applicable in a NTN network, as shown in FIG. 1.

At step s210, the terminal node receives information on a measurement configuration of the type of reference signal from a network node, the measurement configuration being determined so that an occupied time length of SMTC or MG in one measurement periodicity is not higher than a threshold.

At step s220, the terminal node performs a measurement procedure of the type of reference signal based on the measurement configuration.

In an exemplary embodiment, the measurement configuration may comprise a SMTC configuration comprising at least one of:
SMTC periodicity;
SMTC length in time or duration;
SMTC offset; and
number of SMTC in one measurement periodicity.

In an exemplary embodiment, the measurement configuration may comprise a MG configuration comprising at least one of:
MG periodicity;
MG length in time or duration; and
MG offset.

In an exemplary embodiment, the network node may inform the terminal node of an exact configuration parameter of the measurement configuration. In another exemplary embodiment, the network node may inform the terminal node of a measurement configuration, e.g., measurement configuration 1, measurement configuration 2. In the embodiment, the information on the measurement configuration may comprise information on one or more of the at least one configuration parameter, or information on one or more measurement configurations from a group of measurement configurations.

In an exemplary embodiment, the network node may adjust the measurement parameter used for the terminal node. For example, the measurement delay of the measurement procedure may be described as CSSF*N*Tsample, where CSSF is a carrier specific scaling factor, N is a number of measurement samples per frequency layer, and Tsample is the measurement time per sample. The network node may change the value of N for a particular scenario. The network node may change the value of N for a particular scenario. In the embodiment, the method 200 may further comprise a step of receiving information on a measurement parameter to be used in the measurement procedure from the network node. In the embodiment, step s220 is further based on the received measurement parameter.

In an exemplary embodiment, the terminal node may indicate the network node that it can support a number of SMTCs under different conditions, or it can support certain number of SMTC configurations for any set of SMTC configuration parameters. In the embodiment, the method 200 may further comprise a step of transmitting capability information to the network node, indicating a capability of the terminal node in the measurement procedure.

In an exemplary embodiment, the terminal node may indicate necessary or supplementary information for determining the measurement configuration to the network node. In the embodiment, the method 200 may further comprise a step of transmitting configuration information on the measurement configuration to the network node. In the embodiment, the configuration information may be an indication of a measurement configuration of the reference signal or an indication of a configuration parameter included in a measurement configuration of the reference signal. Examples of the information may include the SMTC configurations determined by the terminal node, including for example:
Exact SMTC configurations: offset of SMTCs, index or identifier of SMTCs, index or identifier of satellites, index or identifier of cells and so on.
Difference/offset between SMTCs determined by UE and SMTCs configured by network.

In an exemplary embodiment, the terminal node may indicate its allowed, preferred or suggested measurement procedure to the network node. In the embodiment, the method 200 may further comprise a step of transmitting measurement information on the measurement procedure to the network node. In the embodiment, the measurement information may be an indication of a measurement procedure of the reference signal or an indication of a measurement parameter to be used in a measurement procedure of the reference signal.

In an exemplary embodiment, transmission of the configuration information or measurement information is performed in response to a predefined event or a command from the network node. The time when terminal node reports the configuration information or measurement information to the network node can be determined by the terminal node or be triggered by different events or procedures. Examples of the events or procedures may include:
In a specific example, RRC state switch, e.g. RRC reconfiguration, RRC setup, enables terminal node's report
In another specific example, time in time assisted mobility enables terminal node's report.
In another specific example, distance in distance assisted mobility enables terminal node's report.
In another specific example, switch in L1 mobility or L3 mobility, e.g., radio link failure, recovery and handover, enables terminal node's report
In another specific example, expiry of explicit validity timer of SMTC enables terminal node's report
In another specific example, expiry of validity SMTC which is identified by the terminal node enables terminal node's report.
In another specific example, the network node signals the terminal node with RRC signaling, DCI or MAC command to enable terminal node's report.

In an exemplary embodiment, the terminal node may indicate the network node that it has the capability to adapt the measurement configuration, e.g., SMTC window. In the embodiment, the method 200 may further comprise a step of transmitting an adapting capability indication to the network node, indicating that the terminal node is capable of adapting the measurement configuration. In an example, if the network node indicates to disable the adaptive SMTC windows, the terminal node shall perform measurements with respect to SMTC windows configured by the network node. In another example, if the network node indicates to enable the adaptive SMTC windows, the terminal node can select or shift SMTC windows based on calculation by itself.

In an exemplary embodiment, the terminal node may adapt the measurement configuration based on at least one of:
received signal level, location, and time at the terminal node
information on frequency layer and cells
number of satellites
satellite types or satellite ephemeris data
cell number or cell number per satellite
scheduling restriction or data throughput loss due to occupation of SMTC or MG in one measurement periodicity
time in time assisted mobility
distance in distance assisted mobility
Discontinuous Reception, DRX, of the terminal node

In the embodiment, the terminal node may select a preferred measurement configuration by taking the above information into account if the network node enables the terminal node to adapt the measurement configuration.

In an exemplary embodiment, there may be a correspondence between the measurement configuration and the measurement procedure. In the embodiment, in step s220 the terminal node may determine the measurement procedure based on correspondence between the measurement configuration and the measurement procedure. Below is an exemplary embodiment of the correspondence between the measurement configuration and the measurement procedure.

### Correspondence Between Measurement Configuration and Measurement Procedure

| Signaling for measurement | measurement delay of the |
|---|---|
| configuration | measurement procedure |
| MC1 | TNₘₑₛₐᵤᵣₑₘₑₙₜ |
| MC2 | f(K2, TNₘₑₛₐᵤᵣₑₘₑₙₜ) |
| MC3 | f(K3, TNₘₑₛₐᵤᵣₑₘₑₙₜ) |

In the above table, TNₘₑₐₛᵤᵣₑₘₑₙₜ represent a baseline of measurement delay, and f(K2/K3, TNₘₑₐₛᵤᵣₑₘₑₙₜ) represents the final measurement delay is K2(K3)*TNₘₑₛₐᵤᵣₑₘₑₙₜ.

In an exemplary embodiment, the method 200 may further comprise a step of performing the measurement procedure of the reference signal.

In an exemplary embodiment, the performing the measurement procedure of the reference signal is performed in response to receiving a measurement enablement message from the network node, indicating the terminal node to perform the measurement procedure of the reference signal. For example, the terminal node determines the measurement procedure based on the measurement configuration from the network node, but holds on the performing of the determined measurement procedure until being commanded by the network node.

In an exemplary embodiment, the terminal node may perform transmitting to the network node by explicit signaling, including RRC signaling, DCI and MAC command, or implicit signaling.

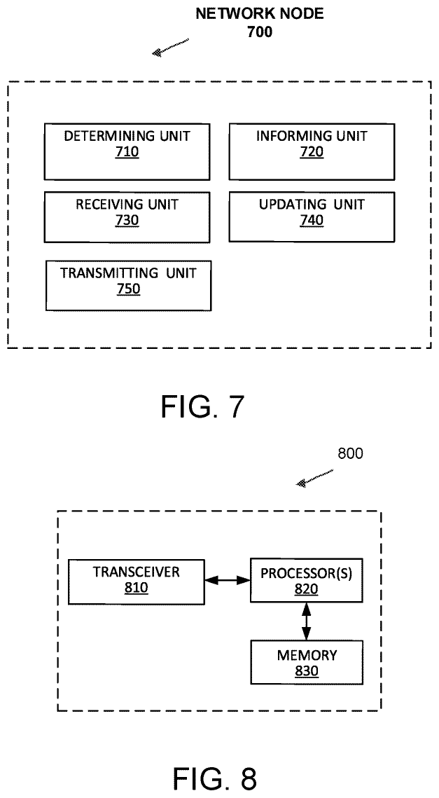

Correspondingly to the method 100 as described above, a network node is provided. FIG. 7 is a block diagram of a network node 700 according to an exemplary embodiment of the present disclosure.

As shown in FIG. 7, the network node 700 includes a determining unit 710 configured to determine a measurement configuration of a type of reference signal based on at least one criterion. The measurement configuration comprises at least one of a SMTC configuration and a MG configuration. The criterion may be that an occupied time length of SMTC or MG in one measurement periodicity is not higher than a threshold.

The network node 700 further include an informing unit 720 configured to inform the terminal node of the determined measurement configuration. The determined measurement configuration is to be used at the terminal node for performing a measurement procedure of the type of reference signal.

The network node 700 may further include a receiving unit 730 configured to receive report or information on the measurement configuration or measurement procedure from the terminal node.

The network node 700 may further include an updating unit 740 configured to update the measurement configuration in response to receiving information related to the measurement configuration from the terminal node.

The network node 700 may further include a transmitting unit 750 configured to transmit information related to the measurement configuration or measurement procedure to the terminal node.

The determining unit 710, the informing unit 720, the receiving unit 730, the updating unit 740 and/or the transmitting unit 750 of the network node 700 may be configured to perform the actions discussed with FIG. 5 to implement the function of the network node.

The units 710-750 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5.

FIG. 8 is a block diagram of a network node 800 according to another embodiment of the present disclosure.

The network node 800 includes a transceiver 810, a processor 820 and a memory 830. The memory 830 contains instructions executable by the processor 820 whereby the network node 800 is operative to perform the actions, e.g., of the procedure described earlier in conjunction with FIG. 5.

In an exemplary embodiment, the memory 830 contains instructions executable by the processor 820 whereby the network node 800 is operative to determine a measurement configuration of a type of reference signal based on at least one criterion, and to inform the terminal node of the determined measurement configuration. The measurement configuration comprises at least one of a SMTC configuration and a MG configuration. The criterion may be that an occupied time length of SMTC or MG in one measurement periodicity is not higher than a threshold. The determined measurement configuration is to be used at the terminal node for performing a measurement procedure of the type of reference signal.

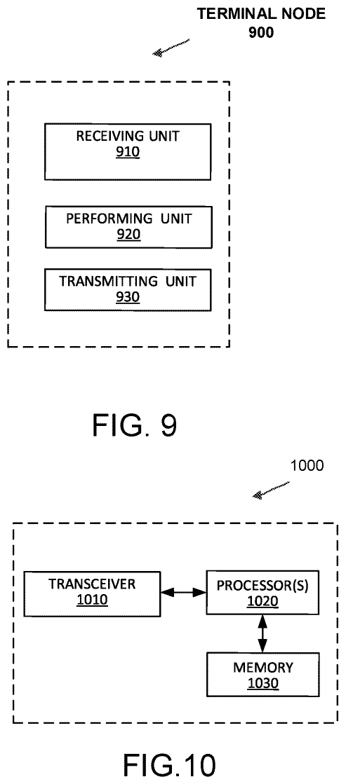

Correspondingly to the method 200 as described above, a terminal node is provided. FIG. 9 is a block diagram of a terminal node 900 according to an exemplary embodiment of the present disclosure.

As shown in FIG. 9, the terminal node 900 includes a receiving unit 910 configured to receive information on a measurement configuration of a type of reference signal from a network node. The measurement configuration comprises at least one of a SMTC configuration and a MG configuration. The received measurement configuration is determined so that an occupied time length of SMTC or MG in one measurement periodicity is not higher than a threshold.

The terminal node 900 may further include a performing unit 920 configured to perform a measurement procedure of the type of reference signal based on the measurement configuration.

The terminal node 900 may further include a transmitting unit 930 configured to transmit report or information on the measurement configuration or measurement procedure to the network node.

The receiving unit 910, the performing unit 920, and the transmitting unit 930 of the terminal node 900 may be configured to perform the actions discussed with FIG. 6 to implement the function of the terminal node.

The units 910-930 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 6.

FIG. 10 is a block diagram of a terminal node 1000 according to another embodiment of the present disclosure.

The terminal node 1000 includes a transceiver 1010, a processor 1020 and a memory 1030. The memory 1030 contains instructions executable by the processor 1020 whereby the terminal node 1000 is operative to perform the actions, e.g., of the procedure described earlier in conjunction with FIG. 6.

In an exemplary embodiment, the memory 1030 contains instructions executable by the processor 1020 whereby the terminal node 1000 is operative to receive information on a measurement configuration of a type of reference signal from a network node, and to perform a measurement procedure of the reference signal based on the received measurement configuration. The measurement configuration comprises at least one of a SMTC configuration and a MG configuration. The received measurement configuration is determined so that an occupied time length of SMTC or MG in one measurement periodicity is not higher than a threshold.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 820 causes the network node 800 to perform the actions, e.g., of the procedure described earlier in conjunction with FIG. 5; or code/computer readable instructions, which when executed by the processor 1020 causes the terminal node 1000 to perform the actions, e.g., of the procedure described earlier in conjunction with FIG. 6.

The computer program product may be configured as a computer program code structured in computer program modules. The computer program modules could essentially perform the actions of the flow illustrated in FIG. 5 or FIG. 6.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

The disclosure is not limited to the foregoing embodiments, and may further comprise the following embodiments.

### 1.1 Outlines

The proposed solution(s) is a mechanism for the network (NW) in NTN to conditionally or adaptively adjust measurement configuration (e.g. SMTC or measurement gap) based on rules presented herein, and a mechanism for the UE in NTN (e.g. UE served by a NTN network, e.g. network node, gNB) to conditionally or adaptively adjust measurement configuration (e.g. SMTC or measurement gap) and measurement procedure (measurement delay or measurement periodicity) based on rules presented herein.

According to the first embodiment, the proposed solution comprises that the network, e.g. gNB, provides a UE with measurement configuration, optionally associated with one or more neighbor cell(s), with respect to UE's capability, SMTC configurations, and MG configurations, e.g. number of SMTC, SMTC window, SMTC periodicity, SMTC offset, MG length, MG repetition periodicity, MG offset, cell number, satellite ephemeris data, satellite number, satellite type, UE's position.

One aspect of the embodiment is that UE shall perform different measurement procedures to meet measurement configuration.
In one example, the network shall configure measurement configuration, taking scheduling restriction or data throughput loss due to occupation of SMTC or MG in one measurement period into account, e.g. shall not higher than TL1%.
In another example, UE shall perform measurement procedure with respect to the number of SMTCs.
In another example, UE shall perform measurement procedure, with respect to evaluation results on restriction or data throughput loss due to SMTC or MG in one measurement periodicity into account, e.g. measurement periodicity shall be scaled if throughput loss is higher than TL2%. Here TL is an exemplary threshold, and may be the threshold for the throughput loss (TL) for example.

According to the second embodiment, the proposed solution comprises that the UE informs the network of its allowed, preferred or suggested measurement configuration and measurement procedure. The signaling includes explicit or implicit signaling, e.g. acknowledgement, prioritization or adaption on each measurement configuration and measurement procedure, e.g. SMTC or MG configurations, e.g. number of SMTC, SMTC window, SMTC periodicity, SMTC offset, MG length, MG repetition periodicity, MG offset, cell number, satellite ephemeris data, satellite number, satellite type, UE's position, also corresponding measurement periodicity or measurement delay.
In one example, if scheduling restriction or data throughput loss due to SMTC or MG in one measurement periodicity achieves TL3%, UE shall indicate it to the network and the network shall update measurement configuration based on UE's feedback and UE follows new measurement configuration and measurement procedure.
In another example, UE shall indicate its boundary of scheduling restriction or data throughput loss, TL4%, to the network and the network shall update measurement configuration based on UE's feedback and UE follows new measurement configuration and measurement procedure.

According to the third embodiment, the network enables or disables measurement configuration among those have been configured to a UE by RRC signaling, DCI or MAC command. One aspect of the embodiment is that UE shall perform measurement procedure following update of measurement configuration.

According to the fourth embodiment, the network indicates measurement procedure that UE shall follow by RRC signaling, DCI or MAC command.

### 1.2 Criteria for the Network Determining Measurement Configuration

In the proposed solution(s), the network in NTN conditionally or adaptively adjust measurement configuration (e.g. SMTC or MG) based on rules as follows.

The network determines measurement configurations configured by the network in a MO for certain carrier frequency based on one or more criteria or rule or condition.

Measurement configuration informed to UE may include exact measurement configuration and set or group of measurement configuration: measurement configuration 1 (MC1), MC2 and so on by RRC signaling, DCI or MAC command. The network indicates which set or group of measurement configuration to be utilized.

An example of group or set of measurement configuration is depicted in Table 2, where NSMTC is number of SMTC in one measurement periodicity, OSMTC is offset of SMTC, MGL is duration of MG in one measurement periodicity.

TABLE 2
Signaling for measurement configuration

| Signaling for measurement | |
|---|---|
| configuration | Measurement configuration |
| MC1 | NSMTC_1, OSMTC_1, MGL_1 . . . |
| MC2 | NSMTC_2, OSMTC_2, MGL_2 . . . |
| . . . | . . . |
| MCn | NSMTC_n, OSMTC_n, MGL_n . . . |

The one or more criteria or certain aspects of the criteria can be pre-defined and/or configured by the network. Examples of parameters for criteria are:
Received signal level, location, time and other kinds of metrics at the UE
Frequency layer and cells, e.g. number of frequency layer and cells
Number of satellites
Satellite types or ephemeris date of satellites
Time in time assisted mobility, e.g. CHO or reselection
Distance in distance assisted mobility, e.g. CHO or reselection
DRX

With respect to above example parameters, the network determines the measurement configuration.

In one example of the criterion, the network determines the SMTC configuration based on a relation between a received signal level(S) at the UE in a cell (e.g. cell1) and a signal level threshold (SH). In general, the measurement configuration j (e.g. SMTCj) is selected from maximal configurable measurement configuration i (e.g. SMTCi) by the network based on relation or function between S and threshold (SH). A general example of a function for determining SMTCj based on relation between S and SH is expressed as follows:

SMTCj=f1(SMTCi,S,SH)

In one specific example,

SMTCj=SMTCi where,RSRP(SMTCi)>SH

In another example of the criterion, the network determines the SMTC configuration based on a relation between time duration (T) at the UE in a cell (e.g. cell1) and a timing threshold (TH). In general, the measurement configuration j (e.g. SMTCj) is selected based on relation or function between T and threshold (TH). A general example of a function for determining SMTCj based on relation between T and TH is expressed as follows:

SMTCj=f2(SMTCi,T,TH)

In one specific example,

SMTCj=SMTCi where,time duration(SMTCi)>TH

In another example of the criterion, the network determines the SMTC configuration based on satellite type and satellite ephemeris data. In general, the measurement configuration j (e.g. SMTCj) is selected based on relation or function of satellite information (Sk,m,l), where k is number or index/identifier of satellite, m is number or index of frequency layer, l is number of or index of cells (e.g. more than one satellites connects one cell).
An example is for LEO satellites, due to moving characteristics, one SMTC may contain less satellites compared to GEO satellite. Another example is for LEO satellites, due to moving characteristics, number of SMTC may be less to GEO satellite.
Another example is number of SMTC may be less if monitoring frequency layer less.
A general example of a function for determining SMTCj based on Sk,m,l is expressed as follows:

SMTCj=f3(SMTCi,Sk,m,l)

In one specific example,

SMTCj=SMTCi

where satellites in SMTCi belongs to Sk, m, l, where k, m, l are predefined or configured by the network.

In another example of the criterion, the network determines the SMTC configuration based on cell number or cell number per satellite (e.g. more than one cells connects one satellite). In general, the measurement configuration j (e.g. SMTCj) b is selected based on relation or function of cell information (Ck, m, l), where k is number or index/identifier of cell, m is number or index of frequency layer, l is number of or index of satellites per cell).
An example is for LEO satellites, due to moving characteristics, one SMTC may contain less cells compared to GEO satellite. Another example is for LEO satellites, due to moving characteristics, number of SMTC may be less to GEO satellite.
Another example is number of SMTC may be less if monitoring frequency layer less.

A general example of a function for determining SMTCj based on Ck,m,l is expressed as follows:

SMTCj=f4(SMTCi,Ck,m,l)

In one specific example,

SMTCj=SMTCi

where cells in SMTCi belongs to Ck,m,l, where k,m,l are predefined or configured by the network.

In another example, measurement configuration by the network shall avoid percentage of scheduling restriction or data throughput loss due to SMTC or MG in one measurement periodicity i higher than TL1%, where TL1 can be pre-defined, configured by the network or reported by UE. A general example of a function for determining SMTCj based on TL1% is expressed as follows:

SMTCj=f5(SMTCi,TL1%)

In one specific example, the total occupied time length (SMTCj)/periodicity<TL1%, where SMTCj is a subset of SMTCi.

It is noted that measurement configuration can be relevant to one of above functions or combination of more than one function.

SMTCj=f6(SMTCi,S,SH,T,TH,Sk,m,l,Ck,m,l,TL1)

For sure, once SMTC is configured, MG shall be configured also with similar criteria to SMTC. In other words, above criteria for SMTC configuration also can be used in MG configuration.
In an extra example, measurement configuration with above function is scaled differently with different DRX.
In another extra example, measurement configuration with above function is scaled differently with time in time assisted mobility, or distance in distance assisted mobility, e.g. CHO or reselection.

### 1.3 Measurement Procedure

In one example the measurement or measurement procedure, e.g. performing intra-frequency measurement, inter-frequency measurement enables the UE, while maintaining the connection with the network, to measure on signals with different rate and/or periodicity and/or over different time period in certain RRC state with available, enabled or valid SMTCs or MGs.

Also, measurement procedure shall take frequency layer, cell and satellites and other assistance information into account, e.g.
Received signal level, location, time and other kinds of metrics at the UE
Number of frequency layer and cells
Number of satellites
Satellite types or ephemeris date of satellites
Time in time assisted mobility, e.g. CHO or reselection
Distance in distance assisted mobility, e.g. CHO or reselection
DRX

UE shall perform measurement procedure with respect to above example parameters.

Here, TNₘₑₐₛᵤᵣₑₘₑₙₜ represents a baseline of measurement delay, which may be the measurement delay in the measurement procedure. The measurement delay may be generalized as: CSSF*N*Tsample, where CSSF is a carrier specific scaling factor, N is a number of measurement samples per frequency layer, and Tsample is the measurement time per sample.

In one example, UE shall perform measurement procedure, with respect to scheduling restriction or data throughput loss due to occupation of SMTC or MG in one measurement periodicity into account, e.g. measurement periodicity shall be scaled if throughput loss is higher than TL2%. An Example of function for determining Measurement time based on scheduling restriction may be expressed as follows:

Measurement delay=f7(TNₘₑₐₛᵤᵣₑₘₑₙₜ,SMTCj,MGj)

In one specific example,

$$Measurement delay = CSSF * N * Tsample * COUNT ( SMTCj )$$

An Example of function for determining Measurement time based on scheduling restriction may be expressed as follows:

Measurement delay=f8(TNₘₑₐₛᵤᵣₑₘₑₙₜ,Sk,m,l)

In one specific example,

$$Measurement delay = CSSF * N * Tsample * COUNT ( Sk , m , l )$$

An Example of function for determining Measurement time based on scheduling restriction may be expressed as follows:

Measurement delay=f9(TNₘₑₐₛᵤᵣₑₘₑₙₜ,Ck,m,l)

In one specific example,

$$Measurement delay = CSSF * N * Tsample * COUNT ( Ck , m , l )$$

An Example of function for determining Measurement time based on scheduling restriction may be expressed as follows:

Measurement delay=f10(TNₘₑₐₛᵤᵣₑₘₑₙₜ,TL2)

In one specific example,

$$Measurement delay = CSSF * N * Tsample * COUNT ( SMTCj , where total occupied time length ( SMTCj ) / periodicity < TL 2 \% , )$$

where COUNT (x) means the overall number of the sequence x.

It is noted that measurement delay can be relevant to one of above functions or combination of more than one function, for example:

Measurement delay=f11(SMTCj,MGj,Sk,m,l,Ck,m,l,TL2))

In an extra example, measurement time is scaled with number of SMTC, MG or TL2 and scaling factor fact may be different for different DRX.

In another extra example, measurement time is scaled with time in time assisted mobility, or distance in distance assisted mobility, e.g. CHO or reselection.

### 1.4 Mapping Between Measurement Procedure and Measurement Configuration

In one example, measurement procedure may be defined with group or set, e.g. MP1, MP2 and so on. Different group or set of measurement procedure comprise different measurement delay or measurement time. The network may indicate UE to follow group or set of measurement procedure with signaling, including RRC signaling, DCI and MAC command. An example of group or set of measurement procedure with different measurement delay or measurement time (here, TNₘₑₐₛᵤᵣₑₘₑₙₜ represents a default measurement delay or measurement time in above paragraphs) is depicted in below Table 3, where the function f(a, TNₘₑₐₛᵤᵣₑₘₑₙₜ) represents a*TNₘₑₐₛᵤᵣₑₘₑₙₜ.

TABLE 3
Signaling for measurement procedure

| Signaling for measurement procedure | measurement delay |
|---|---|
| MP1 | TNₘₑₛₐᵤᵣₑₘₑₙₜ |
| MP2 | f(K2, TNₘₑₛₐᵤᵣₑₘₑₙₜ) |
| MP3 | f(K3, TNₘₑₛₐᵤᵣₑₘₑₙₜ) |

In a specific example, K=2 in MP2 when measurement for GEO satellite and LEO Earth-fixed satellite; K=1/2 in MP3 when measurement for LEO Earth-moving satellite.

In another specific example, K=2 in MP2 when measurement for satellites with huge Doppler shift each other; K=1/2 in MP3 when measurement for satellites with little Doppler shift each other.

In another example, different group or set of measurement procedure corresponds to different measurement configuration with explicit signaling for measurement configuration. The correspondence is shown in Table 4. If UE receives signaling for measurement configuration, the corresponding group or set of measurement procedure shall be followed with predefined rule or mapping.

TABLE 4
Correspondence between measurement configuration
and measurement procedure

| Signaling for measurement | |
|---|---|
| configuration | measurement delay |
| MC1 | TNₘₑₛₐᵤᵣₑₘₑₙₜ |
| MC2 | f(K2, TNₘₑₛₐᵤᵣₑₘₑₙₜ) |
| MC3 | f(K3, TNₘₑₛₐᵤᵣₑₘₑₙₜ) |

Another example of correspondence between group or set of measurement procedure and different measurement configuration is shown in Table 5, if UE is configured with certain measurement configuration, the corresponding group or set of measurement procedure shall be followed with predefined rule or mapping.
A specific example is measurement period can be extended or scaled autonomously once overlapping (partial collision or close in time (e.g. within certain time margin) but do not overlap in time) MG occurs.
Another specific example is measurement period can be extended or scaled autonomously once overlapping (partial collision or close in time (e.g. within certain time margin) but do not overlap in time) SMTC occurs and the satellites which SSBs are in the two SMTCs have significant Doppler shift.

TABLE 5
Correspondence between measurement configuration
and measurement procedure

| | group or set of measurement |
|---|---|
| Measurement configuration | procedure |
| NSMTC_1, OSMTC_1, MGL_1 . . . | TNₘₑₛₐᵤᵣₑₘₑₙₜ |
| NSMTC_2, OSMTC_2, MGL_2 . . . | f(K2, TNₘₑₛₐᵤᵣₑₘₑₙₜ) |
| NSMTC_3, OSMTC_3, MGL_3 . . . | f(K3, TNₘₑₛₐᵤᵣₑₘₑₙₜ) |

### 1.4 UE Reports to the Network

Measurement configurations supported by UE, e.g. SMTC number can be supported under different conditions may be indicated to the network by UE, in terms of one or more parameters related to the SMTC configuration e.g. SMTC proximity distance, SMTC identifier, SMTC periodicity, SMTC offset, SMTC duration etc.

In one example, the UE may indicate that it can support certain number of SMTC configurations for any set of SMTC configuration parameters. In another example, the UE may indicate that it can support certain number of SMTC configurations for specific set of SMTC configuration parameters.
In one example the UE may indicate that the capability of SMTC configurations supported by the UE is different in RRC_IDLE/INACTIVE state and RRC_CONNCETED state.
In another example, capability of SMTC configurations supported by UE can be same in RRC_IDLE/INACTIVE state and RRC_CONNCETED state.

The UE may indicate necessary information on determining SMTCs to the network.

Example of criteria to determine SMTCs are:
Power level, e.g. RSRP, RSRQ or SNR/SINR, on different SMTCs/SSBs
Timing, e.g., time offset between edge of SSB burst set received and edge of SMTC
Satellite's characteristics, e.g., velocity, Satellite identifier, Doppler shift, position, type, priority, footprint, altitude, on different SMTCs/SSBs
Cell characteristics, e.g., cell identifier, priority, footprint, UE's position to cell center/edge, on different SMTCs/SSBs

Examples of the information are SMTCs information, e.g. SMTC configurations determined by the UE. The information may comprise:
Exact SMTC configurations: offset of SMTCs, index or identifier of SMTCs, index or identifier of satellites, index or identifier of cells and so on.
Difference/offset between SMTCs determined by UE and SMTCs configured by the network.
Raw data in above criteria

UE shall inform the network of its allowed, preferred or suggested measurement configuration and the signaling may be explicit signaling, including RRC signaling, DCI and MAC command, or implicit signaling. The signaling may be specific configuration parameters, e.g. certain index of SMTC or MG, offset of SMTC, or set or group of measurement configuration: MC1, MC2 and so on.

UE shall inform the network of its allowed, preferred or suggested measurement procedure includes explicit signaling, including RRC signaling, DCI and MAC command, or implicit signaling including MP1, MP2 and so on.
In an example, if UE determines offset of SMTC or MG configured by the network shall be updated, but the network has not updated SMTC, UE shall update measurement configuration and report to the network, optionally, the network updates measurement configuration, to ensure proper SMTC allocated to the UE.
In another example, if scheduling restriction or data throughput loss due to SMTC or MG in one measurement periodicity achieves TL3%, UE shall report to the network and the network shall update measurement configuration, to ensure scheduling restriction or data throughput loss less than TL3% and UE follows new measurement configuration and measurement procedure.
In another example, UE shall indicate its boundary of scheduling restriction or data throughput loss, TL4%, to the network and the network shall update measurement configuration based on UE's feedback and UE follows new measurement configuration and measurement procedure.
In another example, UE shall indicate measurement procedure, e.g., scaling factor of measurement time, or set or group of measurement procedure, to the network with explicit signaling on measurement procedure, including RRC signaling, DCI and MAC command, or signaling on index or identifier of measurement procedure including MP1, MP2 and so on.

Before UE reports and the network completes update, measurement configuration and measurement procedure follow MCx and MPx.

In one particular example:
In MCx, SMTCi belongs to Ckx, mx, Ix, where kx, mx, Ix are predefined or configured by the network.
In MPx, Measurement delay=CSSF*N*Tsample*COUNT (SMTCjx)

After UE reports and the network completes update, measurement configuration and measurement procedure follow MCy and MPy.

In one particular example:
In MCy, SMTCi belongs to Cky, my, ly, where ky, my, ly are predefined or configured by the network
In MPy, Measurement delay=CSSF*N*Tsample*COUNT (SMTCjy) where ky, my, ly are different from kx, mx, Ix, and SMTCjx is different from SMTCjy.

The time when UE reports can be determined by UE or be triggered by different events or procedures:
In a specific example, RRC state switch, e.g. RRC reconfiguration, RRC setup, enables UE's report
In another specific example, time in time assisted mobility enables UE's report
In another specific example, distance in distance assisted mobility enables UE's report
In another specific example, switch in L1 mobility or L3 mobility, e.g. radio link failure, recovery and handover, enables UE's report.
In another specific example, expiry of explicit validity timer of SMTC enables UE's report.
In another specific example, expiry of validity SMTC which is identified by UE, enables UE's report.
In another specific example, the network signals UE with RRC signaling, DCI or MAC command to enable UE's report

The transition range from MCx and MPx to MCy and MPy, the requirements can follow MCtrans, and MPtrans.

In one specific example, MCtrans=MCx and MPtrans=MPx.

In another specific example, MCtrans=MCy and MPtrans=MPy.

In another specific example, MCtrans=max (MCx, MCy) and MPtrans=max (MPx, MPy).

In another specific example, MCtrans=min (MCx, MCy) and MPtrans=min (MPx, MPy).

UE may report to the network whether it has the capability to support the adaptive SMTC windows. If UE supports the capability and the network configures the indication to enable or disable UE to determination on SMTC configurations through RRC signaling, DCI or MAC command. In an example, if the network indicates to disable the adaptive SMTC windows, UE shall perform measurements with respect to SMTC configured by the network. In another example, if the network indicates to enable the adaptive SMTC windows, UE can select or shift SMTC windows based on calculation by itself.

Alternative option is that the network informs UE if the network adopts SMTC configurations determined by UE or not through RRC signaling, DCI or MAC command. In an example, if the network indicates UE that the network doesn't adopt UE's SMTC, then UE doesn't need to send report.

### 1.5 Enable and Disable Measurement Configuration and Update Measurement Procedure

The network enables or disables measurement configuration among those have been configured to a UE by RRC signaling, DCI or MAC command. And UE shall perform measurement procedure following update of measurement configuration.

The network determines measurement procedure to a UE by RRC signaling, DCI or MAC command. And UE shall perform measurement procedure following update of measurement configuration. The signaling may be specific configuration parameters, e.g. certain index of SMTC or MG, or set or group of measurement configuration: MC1, MC2 and so on.
In one example, the network configures M SMTCs or MGs to all UEs or particular UE, UE shall not perform measurement procedure until the network enable specific SMTCs or MGs by RRC signaling, DCI or MAC command.
In another example, the network configures M SMTCs or MGs to all UEs or particular UE, UE shall perform all configured measurement procedure until the network disable specific SMTCs or MGs by RRC signaling, DCI or MAC command.

Typically, scheduling restriction shall be applied SSB symbols under some conditions, e.g. The UE is not expected to transmit PUCCH/PUSCH/SRS and receive PDSCH/PDCCH/CSI-RS on SSB symbols to be measured, on number of symbols before and after each consecutive SSB symbols to be measured, or on all symbols within SMTC window duration.
In one example, if the network configures M SMTCs or MGs to all UEs or particular UE, scheduling restriction is applied all those SMTCs or MGs.
In another example, some SMTC or MGs are enabled and some SMTC or MGs are disabled. Scheduling restriction shall be allied on enabled SMTC or MGs, and no scheduling restriction shall be allied on disabled SMTC or MGs.

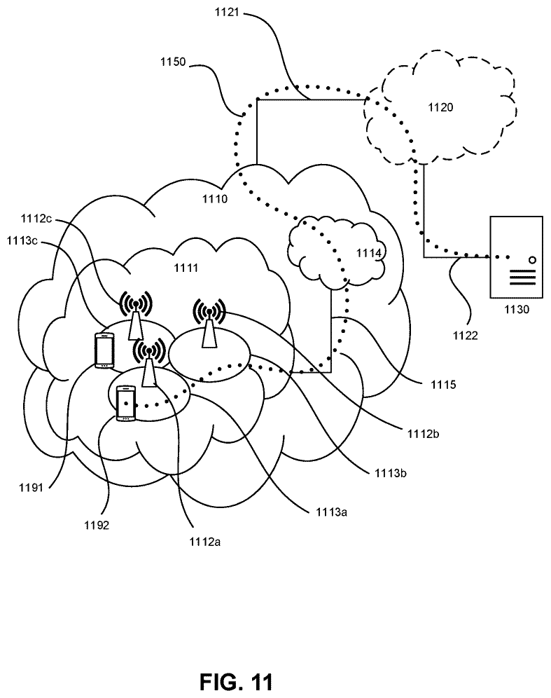

With reference to FIG. 11, in accordance with an embodiment, a communication system includes telecommunication network 1110, such as a 3GPP-type cellular network, which comprises access network 1111, such as a radio access network, and core network 1114. Access network 1111 comprises a plurality of base stations 1112a, 1112b, 1112c, such as NBs, eNBs, gNBs or other types of wireless access points, each defining a corresponding coverage area 1113a, 1113b, 1113c. Each base station 1112a, 1112b, 1112c is connectable to core network 1114 over a wired or wireless connection 1115. A first UE 1191 located in coverage area 1113c is configured to wirelessly connect to, or be paged by, the corresponding base station 1112c. A second UE 1192 in coverage area 1113a is wirelessly connectable to the corresponding base station 1112a. While a plurality of UEs 1191, 1192 are illustrated in this example, the disclosed embodiments are equally applicable to a situation where a sole UE is in the coverage area or where a sole UE is connecting to the corresponding base station 1112.

Telecommunication network 1110 is itself connected to host computer 1130, which may be embodied in the hardware and/or software of a standalone server, a cloud-implemented server, a distributed server or as processing resources in a server farm. Host computer 1130 may be under the ownership or control of a service provider, or may be operated by the service provider or on behalf of the service provider. Connections 1121 and 1122 between telecommunication network 1110 and host computer 1130 may extend directly from core network 1114 to host computer 1130 or may go via an optional intermediate network 1120. Intermediate network 1120 may be one of, or a combination of more than one of, a public, private or hosted network; intermediate network 1120, if any, may be a backbone network or the Internet; in particular, intermediate network 1120 may comprise two or more sub-networks (not shown).

The communication system of FIG. 11 as a whole enables connectivity between the connected UEs 1191, 1192 and host computer 1130. The connectivity may be described as an over-the-top (OTT) connection 1150. Host computer 1130 and the connected UEs 1191, 1192 are configured to communicate data and/or signaling via OTT connection 1150, using access network 1111, core network 1114, any intermediate network 1120 and possible further infrastructure (not shown) as intermediaries. OTT connection 1150 may be transparent in the sense that the participating communication devices through which OTT connection 1150 passes are unaware of routing of uplink and downlink communications. For example, base station 1112 may not or need not be informed about the past routing of an incoming downlink communication with data originating from host computer 1130 to be forwarded (e.g., handed over) to a connected UE 1191. Similarly, base station 1112 need not be aware of the future routing of an outgoing uplink communication originating from the UE 1191 towards the host computer 1130.

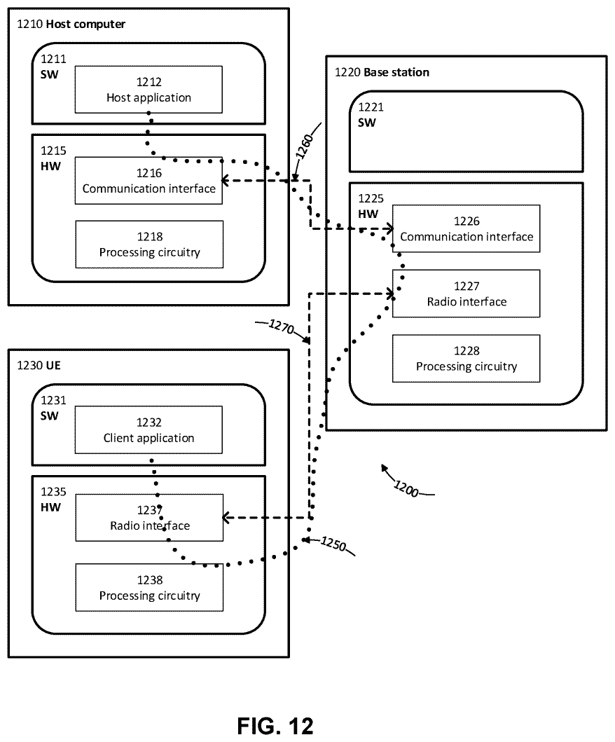

Example implementations, in accordance with an embodiment, of the UE, base station and host computer discussed in the preceding paragraphs will now be described with reference to FIG. 12. In communication system 1200, host computer 1210 comprises hardware 1215 including communication interface 1216 configured to set up and maintain a wired or wireless connection with an interface of a different communication device of communication system 1200. Host computer 1210 further comprises processing circuitry 1218, which may have storage and/or processing capabilities. In particular, processing circuitry 1218 may comprise one or more programmable processors, application-specific integrated circuits, field programmable gate arrays or combinations of these (not shown) adapted to execute instructions. Host computer 1210 further comprises software 1211, which is stored in or accessible by host computer 1210 and executable by processing circuitry 1218. Software 1211 includes host application 1212. Host application 1212 may be operable to provide a service to a remote user, such as UE 1230 connecting via OTT connection 1250 terminating at UE 1230 and host computer 1210. In providing the service to the remote user, host application 1212 may provide user data which is transmitted using OTT connection 1250.

Communication system 1200 further includes base station 1220 provided in a telecommunication system and comprising hardware 1225 enabling it to communicate with host computer 1210 and with UE 1230. Hardware 1225 may include communication interface 1226 for setting up and maintaining a wired or wireless connection with an interface of a different communication device of communication system 1200, as well as radio interface 1227 for setting up and maintaining at least wireless connection 1270 with UE 1230 located in a coverage area (not shown in FIG. 12) served by base station 1220. Communication interface 1226 may be configured to facilitate connection 1260 to host computer 1210. Connection 1260 may be direct or it may pass through a core network (not shown in FIG. 12) of the telecommunication system and/or through one or more intermediate networks outside the telecommunication system. In the embodiment shown, hardware 1225 of base station 1220 further includes processing circuitry 1228, which may comprise one or more programmable processors, application-specific integrated circuits, field programmable gate arrays or combinations of these (not shown) adapted to execute instructions. Base station 1220 further has software 1221 stored internally or accessible via an external connection.

Communication system 1200 further includes UE 1230 already referred to. Its hardware 1235 may include radio interface 1237 configured to set up and maintain wireless connection 1270 with a base station serving a coverage area in which UE 1230 is currently located. Hardware 1235 of UE 1230 further includes processing circuitry 1238, which may comprise one or more programmable processors, application-specific integrated circuits, field programmable gate arrays or combinations of these (not shown) adapted to execute instructions. UE 1230 further comprises software 1231, which is stored in or accessible by UE 1230 and executable by processing circuitry 1238. Software 1231 includes client application 1232. Client application 1232 may be operable to provide a service to a human or non-human user via UE 1230, with the support of host computer 1210. In host computer 1210, an executing host application 1212 may communicate with the executing client application 1232 via OTT connection 1250 terminating at UE 1230 and host computer 1210. In providing the service to the user, client application 1232 may receive request data from host application 1212 and provide user data in response to the request data. OTT connection 1250 may transfer both the request data and the user data. Client application 1232 may interact with the user to generate the user data that it provides.

It is noted that host computer 1210, base station 1220 and UE 1230 illustrated in FIG. 12 may be similar or identical to host computer 1130, one of base stations 1112a, 1112b, 1112c and one of UEs 1191, 1192 of FIG. 11, respectively. This is to say, the inner workings of these entities may be as shown in FIG. 12 and independently, the surrounding network topology may be that of FIG. 11.

In FIG. 12, OTT connection 1250 has been drawn abstractly to illustrate the communication between host computer 1210 and UE 1230 via base station 1220, without explicit reference to any intermediary devices and the precise routing of messages via these devices. Network infrastructure may determine the routing, which it may be configured to hide from UE 1230 or from the service provider operating host computer 1210, or both. While OTT connection 1250 is active, the network infrastructure may further take decisions by which it dynamically changes the routing (e.g., on the basis of load balancing consideration or reconfiguration of the network).

Wireless connection 1270 between UE 1230 and base station 1220 is in accordance with the teachings of the embodiments described throughout this disclosure. One or more of the various embodiments improve the performance of OTT services provided to UE 1230 using OTT connection 1250, in which wireless connection 1270 forms the last segment. More precisely, the teachings of these embodiments may improve the radio resource utilization and thereby provide benefits such as such as reduced UE power consumption.

A measurement procedure may be provided for the purpose of monitoring data rate, latency and other factors on which the one or more embodiments improve. There may further be an optional network functionality for reconfiguring OTT connection 1250 between host computer 1210 and UE 1230, in response to variations in the measurement results. The measurement procedure and/or the network functionality for reconfiguring OTT connection 1250 may be implemented in software 1211 and hardware 1215 of host computer 1210 or in software 1231 and hardware 1235 of UE 1230, or both. In embodiments, sensors (not shown) may be deployed in or in association with communication devices through which OTT connection 1250 passes; the sensors may participate in the measurement procedure by supplying values of the monitored quantities exemplified above, or supplying values of other physical quantities from which software 1211, 1231 may compute or estimate the monitored quantities. The reconfiguring of OTT connection 1250 may include message format, retransmission settings, preferred routing etc.; the reconfiguring need not affect base station 1220, and it may be unknown or imperceptible to base station 1220. Such procedures and functionalities may be known and practiced in the art. In certain embodiments, measurements may involve proprietary UE signaling facilitating host computer 1210's measurements of throughput, propagation times, latency and the like. The measurements may be implemented in that software 1211 and 1231 causes messages to be transmitted, in particular empty or ‘dummy’ messages, using OTT connection 1250 while it monitors propagation times, errors etc.

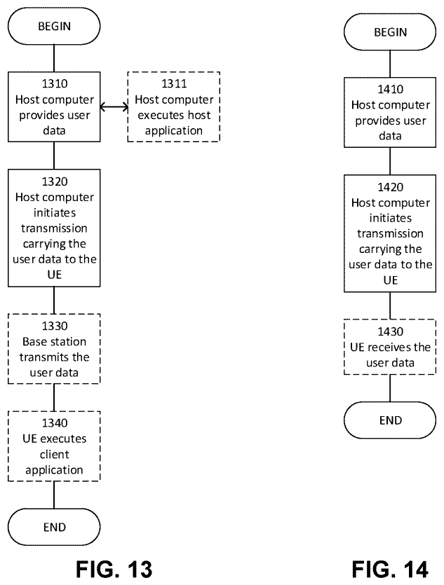

FIG. 13 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 13 will be included in this section. In step 1310, the host computer provides user data. In substep 1311 (which may be optional) of step 1310, the host computer provides the user data by executing a host application. In step 1320, the host computer initiates a transmission carrying the user data to the UE. In step 1330 (which may be optional), the base station transmits to the UE the user data which was carried in the transmission that the host computer initiated, in accordance with the teachings of the embodiments described throughout this disclosure. In step 1340 (which may also be optional), the UE executes a client application associated with the host application executed by the host computer.

FIG. 14 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 14 will be included in this section. In step 1410 of the method, the host computer provides user data. In an optional substep (not shown) the host computer provides the user data by executing a host application. In step 1420, the host computer initiates a transmission carrying the user data to the UE. The transmission may pass via the base station, in accordance with the teachings of the embodiments described throughout this disclosure. In step 1430 (which may be optional), the UE receives the user data carried in the transmission.

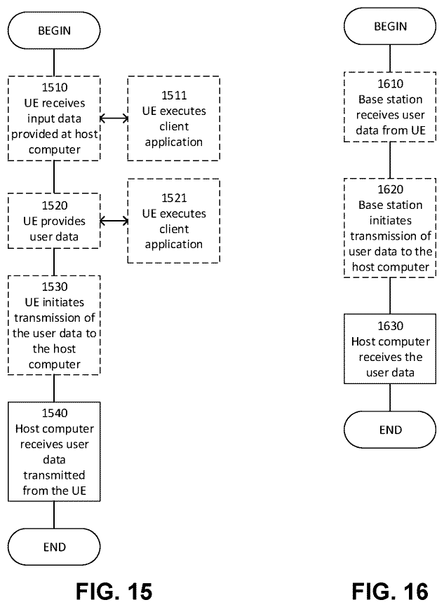

FIG. 15 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 15 will be included in this section. In step 1510 (which may be optional), the UE receives input data provided by the host computer. Additionally or alternatively, in step 1520, the UE provides user data. In substep 1521 (which may be optional) of step 1520, the UE provides the user data by executing a client application. In substep 1511 (which may be optional) of step 1510, the UE executes a client application which provides the user data in reaction to the received input data provided by the host computer. In providing the user data, the executed client application may further consider user input received from the user. Regardless of the specific manner in which the user data was provided, the UE initiates, in substep 1530 (which may be optional), transmission of the user data to the host computer. In step 1540 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 16 will be included in this section. In step 1610 (which may be optional), in accordance with the teachings of the embodiments described throughout this disclosure, the base station receives user data from the UE. In step 1620 (which may be optional), the base station initiates transmission of the received user data to the host computer. In step 1630 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

| Abbreviation | Explanation |
|---|---|
| 3GPP | 3rd Generation |
| 5G | 5th Generation |
| 5GC | 5G Core |
| 5GS | 5G System |
| ASN.1 | Abstract Syntax Notation One |
| bps | bits per second |
| BS | Base Station |
| CE | Control Element |
| C-RNTI | Cell RNTI |
| CSI-RS | Channel State Information Reference Signal |
| DCI | Downlink Control Information |
| DL | Downlink |
| DMRS | Demodulation Reference Signal |
| DRX | Discontinuous Reception |
| eDRX | Extended DRX |
| eMBB | Evolved Mobile Broadband |
| eMTC | Enhanced Machine Type Communication |
| eNB | Evolved NodeB (Radio base station in LTE.) |
| EPC | Evolved Packet Core |
| EPS | Evolved Packet System |
| GEO | Geostationary Earth Orbit |
| GHz | Gigahertz |
| gNB | Radio base station in 5G/NR. |
| GLONASS | Global Navigation Satellite System |
| GNSS | Global Navigation Satellite System |
| GPS | Global Positioning System |
| GW | Gateway |
| HAPS | High Altitude Platform Station/System |
| HIBS | HAPS as IMT Base Station |
| Hz | Hertz |
| ID | Identity/Identifier |
| IMT | International Mobile Telecommunications |
| kHz | Kilohertz |
| LEO | Low Earth Orbit |
| LTE | Long Term Evolution |
| LTE-M | LTE-Machine Type Communication |
| MAC | Medium Access Control |
| MAC CE | MAC Control Element |
| MBB | Mobile Broadband |
| MEO | Medium Earth Orbit |
| mMTC | Massive Machine Type Communication |
| ms | Millisecond |
| NB-IoT | Narrowband Internet of Things |
| NR | New Radio |
| NTN | Non-terrestrial Network |
| PCell | Primary Cell |
| PCI | Physical Cell Identity |
| PDCCH | Physical Downlink Control Channel |
| PDSCH | Physical Downlink Shared Channel |
| PDU | Packet Data Unit |
| PRACH | Physical Random Access Channel |
| PRB | Physical Resource Block |
| PSS | Primary Synchronization Signal |
| PUCCH | Physical Uplink Control Channel |
| PUSCH | Physical Uplink Shared Channel |
| RA | Random Access |
| RAN | Radio Access Network |
| RAT | Radio Access Technology |
| RF | Radio Frequency |
| RMTC | RSSI Measurement Timing Configuration |
| RNTI | Radio Network Temporary Identifier |
| RRC | Radio Resource Control |
| RRM | Radio Resource Management |
| RSRP | Reference Signal Received Power |
| RSRQ | Reference Signal Received Quality |
| RSSI | Received Signal Strength Indicator |
| SFN | System Frame Number |
| SFTD | SFN and Frame Timing Difference |
| SI | System Information |
| SIB | System Information Block |
| SID | Study Item Description |
| SMTC | SSB Measurement Timing Configuration |
| SRS | Sounding Reference Signal |
| SS | Synchronization Signal |
| SSB | Synchronization Signal Block |
| SSID | Service Set Identifier |
| SSS | Secondary Synchronization Signal |
| TA | Timing Advance |
| TR | Technical Report |
| TS | Technical Specification |
| UCI | Uplink Control Information |
| UE | User Equipment |
| UL | Uplink |
| URLLC | Ultra-Reliable Low-Latency Communication |
| UTC | Coordinated Universal Time |

1. A method at a network node for configuring a terminal node with a measurement configuration of a type of reference signal in a Non-Terrestrial Network, NTN, the measurement configuration comprises at least one of a Synchronization Signal Block, SSB, Measurement Time Configuration, SMTC configuration, and a Measurement Gap, MG, configuration, the method comprising:
determining (s110) the measurement configuration based on an occupied time length of SMTC or MG in one measurement periodicity being not higher than a threshold; and
informing (s120) the terminal node of the determined measurement configuration to be used for performing a measurement procedure of the type of reference signal.

2. The method of claim 1, wherein determining the measurement configuration further comprises:
determining the measurement configuration by taking satellite types in the NTN into account.

3. The method of claim 2, wherein determining the measurement configuration by taking satellite types into account comprises selecting different scaling factors of the measurement procedure corresponding to the measurement configuration for different types of satellites.

4. The method of claim 1, wherein determining the measurement configuration further comprises:
determining the measurement configuration based on a number of satellites for which reference signals of the type are measured within one SMTC periodicity, wherein for Low Earth Orbit, LEO, satellites the number of satellites for which reference signals of the type are measured within one SMTC periodicity is less than that for Geostationary Earth Orbit, GEO, satellites.

5. The method of claim 1, wherein determining the measurement configuration further comprises:
applying a scaling factor to measurement period of the measurement procedure corresponding to the measurement configuration if two SMTC partially overlap and the satellites for which reference signals of the type are in the overlapped SMTCs have Doppler shift.

6. The method of claim 5, wherein different scaling factors are applied for different degree of overlapping between two SMTCs.

7. The method of claim 1, wherein determining the measurement configuration further comprises:
determining the measurement configuration based on a number of SMTCs the terminal node is capable of supporting.

8. The method of claim 1, wherein determining the measurement configuration further comprises:
applying a scaling factor to measurement period of the measurement procedure corresponding to the measurement configuration based on a number of SMTCs in one measurement periodicity.

9. The method of claim 1, wherein the measurement configuration comprises a SMTC configuration comprising at least one of:
SMTC periodicity;
SMTC length in time or duration;
SMTC offset; and
number of SMTC in one measurement periodicity.

10. The method of claim 1, wherein the measurement configuration comprises a measurement gap configuration comprising at least one of:
MG periodicity;
MG length in time or duration; and
MG offset.

11. The method of claim 1, wherein determining (s110) the measurement configuration comprises:
selecting one or more measurement configuration from a group of measurement configurations, and
wherein informing (s120) the terminal node of the determined measurement configuration comprises:
informing the terminal node of the one or more selected measurement configurations.

12. The method of claim 1, further comprising:
receiving capability information reported from the terminal node, indicating a capability of the terminal node with respect to a number of SMTCs that can be dealt with in the measurement procedure; and
wherein determining (s110) the measurement configuration comprises determining the measurement configuration by taking the reported capability information into account.

13. The method of claim 1, further comprising:
receiving configuration information on the measurement configuration reported from the terminal node; and
wherein determining (s110) the measurement configuration comprises updating the measurement configuration by taking the reported configuration information into account.

14. The method of claim 13, wherein the configuration information is an indication of a measurement configuration of the type of reference signal or an indication of a configuration parameter included in a measurement configuration of the type of reference signal.

15. The method of claim 1, wherein determining (s110) the measurement configuration further comprises:
updating the measurement configuration in response to receiving information related to the measurement configuration from the terminal node.

16. A method at a terminal node for performing a measurement procedure of a type of reference signal in a Non-Terrestrial Network, NTN, the measurement configuration comprises at least one of a Synchronization Signal Block, SSB, Measurement Time Configuration, SMTC configuration, and a Measurement Gap, MG, configuration, the method comprising:
receiving (s210) information on a measurement configuration of the type of reference signal from a network node, the measurement configuration being determined so that an occupied time length of SMTC or MG in one measurement periodicity is not higher than a threshold; and
performing (s220) a measurement procedure of the type of reference signal based on the measurement configuration.

17. A network node (800) comprising a transceiver (810), a processor (820) and a memory (830), the memory (830) comprising instructions executable by the processor (820) whereby the network node (800) is operative to perform the method according to claim 1.

18. A computer readable storage medium having computer program instructions stored thereon, the computer program instructions, when executed by a processor in a network node, causing the network node to perform the method according to claim 1.

19. A terminal node (1000), comprising a transceiver (1010), a processor (1020) and a memory (1030), the memory (1030) comprising instructions executable by the processor (1020) whereby the terminal node (1000) is operative to perform the method according to claim 16.

20. A computer readable storage medium having computer program instructions stored thereon, the computer program instructions, when executed by a processor in a terminal node, causing the terminal node to perform the method according to claim 16.
